(19) United States
(12) Patent Application Publication
(10) Pub. No.: US 2016/0359514 A1
(43) Pub. Date: Dec. 8, 2016

(54) METHODS AND APPARATUS FOR PROVIDING AN ANTIMICROBIAL COVERING FOR WIRELESS ELECTRONIC DEVICES

(71) Applicants: Kirk Norman, El Dorado Hills, CA (US); Jarrod Morgan, Fair Oaks, CA (US); Michelle Barton, Roseville, CA (US)

(72) Inventors: Kirk Norman, El Dorado Hills, CA (US); Jarrod Morgan, Fair Oaks, CA (US); Michelle Barton, Roseville, CA (US)

(73) Assignee: Clear Image, dba Clear Bags, El Dorado Hills, CA (US)

(21) Appl. No.: 14/729,009

(22) Filed: Jun. 2, 2015

(51) Int. Cl. H04B 1/3888; A45F 5/00; A45C 11/00

(52) U.S. Cl. CPC H04B 1/3888; A45C 11/00; A45F 5/00; A45C 2011/002; A45C 2011/003

(57) ABSTRACT

A cover for a wireless electronic device, comprising a shield forming an envelope defining an interior space configured to receive a wireless electronic device, the shield having at least one opening whereby a wireless electronic device may enter the envelope, the shield being configured to allow a user to operate a wireless electronic device, and the shield comprising an antimicrobial material.

### CROSS-REFERENCE TO OTHER APPLICATIONS

This application claims the benefit of U.S. Provisional Patent Application 62/007353, entitled “METHODS AND APPARATUS FOR PROVIDING AN ANTIMICROBIAL COVERING FOR WIRELESS ELECTRONIC DEVICES,” filed on Jun. 3, 2014.

### TECHNICAL FIELD OF THE INVENTION

Embodiments of the invention are related to antimicrobial covers for wireless electronic devices and methods of applying an antimicrobial layer to a polymer cover.

### BACKGROUND OF THE INVENTION

Maintaining a sanitary and sterile working environment is essential to prevent the spread of germs within hospitals, private medical offices, dental offices, clinics, infirmaries, chiropractors, and other similar health care offices. Bacteria, germs, microorganisms, and diseases can easily spread through facilities such as hospitals and similar medical facilities, such as clinics, infirmaries and private physician's offices. Hospitals and other medical offices have made significant efforts to create sterile working sites in locations such as operating rooms. Furthermore, efforts have been made to sanitize and prevent the spread of germs throughout medical facilities; nevertheless, patients throughout medical facilities still become inflected from a variety of causes within medical facilities.

Many areas of medical facilities could act as sources of infection. These include the aforementioned operating rooms, patient care rooms, waiting rooms, residential rooms, and so forth. People and objects within these areas can carry and store many germs and germs carrying objects. These are common areas where patients, visitors, doctors, nurses, and other health care professionals, all handle or touch various parts of the areas or objects within the area, such as medical devices, telephones, intercoms, beds, furniture, and other equipment. All of these may carrying disease, infection, or other harmful substances. Current and prospective patients, as well as employees and visitors stand the risk of being infected with some type of harmful substance.

Doctors are increasing using more advanced technology to improve and enhance patient care. These methods include the use of wireless electronic devices to gather data about patients and track patient progress. The use of wireless electronic devices in the medical facilities described enhances patient care and brings convenience to the doctors and medical staff as they are able to log patient data and information digitally on wireless electronic devices and share and transfer the data easily, as well as read additional data and journal articles on devices such as electronic readers. These devices may be carried to any area of the hospital, including patient rooms, operating rooms, semi-private and residential rooms, wards, and public lounges. The use of these devices is consistently increasing.

Wireless electronic devices have the ability to store data and to transfer or transmit data to other electronic devices, to laptop and desktop computers, and to central servers, making wireless electronic devices ideally suited to travel with doctors, nurses and other health care professionals from patient room to patient room and into other areas of the hospital. The wireless electronic devices may be placed on countertops, desks, tables, and other locations containing germs. Additionally, multiple doctors, nurses, and other health care professionals may need to use the same wireless electronic device from time to time, and therefore, the wireless electronic devices may need to be handled by multiple health care professionals, patients, and patient visitors, increasing the sharing and the spread of germs through the hospital.

Various attempts have been made to make the medical offices more sanitary. A group of containment coverings includes covers that may be quickly placed over devices more typically used in daily situations. An example is found in U.S. patent application Ser. No. 6,560,335, to Zohn, et al. discloses a cover configured to encapsulate the individual pieces of a telephone, such as an earpiece, a mouth piece, or a handle from a piece of material in a single plane. In some embodiments, these pieces may be formed from templates to enclose a phone or other device. The cover pieces require adhesives and time to be properly configured. US Patent Application No. 2003/0012371 to Weinsock, et al. discloses a covering for a telephone receiver. Weinsock discloses a phone enclosure comprising a mesh enclosure over the ear piece and the mouth microphones, as well as an opening in the handle area of the phone U.S. Pat. No. 8,605,892 to Owens, et. al discloses a protective instrument cover configured to protect equipment configured to remain within a treatment room by covering the equipment while allowing an opening for a cord cover. U.S. Pat. No. 4,939,778, to Tomberlin, discloses a sleeve that enclosing a telephone cord. The sleeve's main function is to prevent the cord from becoming entangled.

Additional attempts at reducing the likelihood of infection from some devices is to enclose the equipment with protective shields to prevent microorganisms already present on or within a piece of equipment from contacting a patient, visitor or healthcare profession who that may use or touch the equipment. For example, U.S. Pat. No. 4,522,196, issued in 1985 to Cunningham, et al. discloses a sterile covering for a surgical camera. The surgical camera comprises a containment cover comprising an attached annular ring. The containment cover enables the attachment of a non-sterile camera to a sterile endoscope. U.S. Pat. No. 5,812,188 to Adair. Adair illustrates an encapsulated endoscopic video monitor cover that is sterile. Adair provides a non-sterile cover for a endoscope video monitor, allowing the monitor to be placed into a sterile field without the possibility of introducing possible infectious microorganisms. Adair comprises a video monitor having a rigid or flexible enclosure that is either transparent or has a transparent window positioned over the video monitor. U.S. Pat. No. 5,792,045, also to Adair, discloses a device for use in an operating room, the device being configured to cover a non-sterile camera. U.S. Pat. No. 5,301,657 to Lafferty, et al. discloses a sleeve to maintain sterile environments during arthroscopic procedures. The sleeve covers the cable of an endoscope extending from the sterile field to a non-sterile TV monitor. Similar to the Cunningham, Laffertyt comprises an annular ring attached to the sleeve to the arthroscope. One drawback of these devices is that they generally lack the flexibility to be used with a variety of different devices.

### BRIEF SUMMARY OF THE INVENTION

In some embodiments, the present invention includes a cover for a wireless electronic device, comprising a shield forming an envelope defining an interior space configured to receive a wireless electronic device. The shield may have at least one opening whereby a wireless electronic device may enter the envelope. The shield may also be configured to allow a user to operate a wireless electronic device. Furthermore, an antimicrobial material may be disposed throughout the shield.

Further embodiments of the present invention include a method of making a cover for a wireless electronic device, comprising forming a shield having an envelope defining an interior space configured to receive a wireless electronic device. The method may also comprise forming the shield to have at least one opening wherein a wireless electronic device may enter the interior space. Furthermore, the method may comprise chemically adding an antimicrobial substance to the disposable shield.

Further embodiments of the present invention include a method of using a shield for a wireless electronic device, comprising inserting a wireless electronic device into at least one opening on the shield. The shield may comprise an antimicrobial substance configured to limit the spread of bacteria. The method may further comprise removing the wireless electronic device from the shield.

These embodiments are necessary to enhance the safety of healthcare facilities because there does not currently exist a method to completely enclose a wireless electronic device that will limit and eliminate the spread of germs and microorganisms transferred from room to room and person to person as the result of the use of wireless electronic devices.

### BRIEF DESCRIPTION OF DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 illustrates a cover for an antimicrobial device having a zipper closure and showing the cover in an open configuration.

FIG. 2 illustrates a wireless electronic device that may be inserted into an antimicrobial shield.

FIG. 3 illustrates a wireless electronic device inserted into an antimicrobial shield.

FIG. 4 illustrates an additional embodiment of an antimicrobial shield, having an alternative opening.

### DETAILED DESCRIPTION

The illustrations presented herein are, in some instances, not actual views of any particular antimicrobial shield, wireless electronic device, or mobile device, but are merely idealized representations which are employed to describe the present invention. Additionally, elements common between figures may retain the same numerical designation.

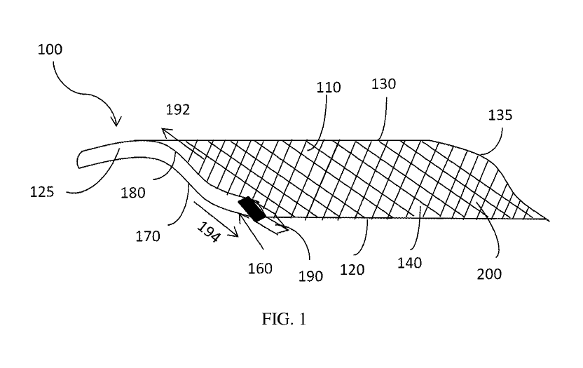

In order that the invention may be more fully understood, it will now be described, by way of example, with reference to the accompanying drawings, FIGS. 1 through 4,

One embodiment of the invention is illustrated in FIG. 1. FIG. 1 shows shield 100 may comprise a polyethylene material. Alternatively, shield 100 may comprise a polypropylene material. Alternatively, shield 100 may comprise similar materials configured to prevent the passage of microorganisms from one side to another side. Such materials may be configured to conduct heat and/or pressure to an object within the shield 100.

Shield 100 may comprise a first sheet 110 and a second sheet 120. First sheet 110 and second sheet 120 may be joined together at three edges, First sheet 110 may be joined to second sheet 120 at first edge 130. First sheet 110 and second sheet 120 may be joined together at first edge 130 by any appropriate method, including, but not limited to fusion bonding, solvent bonding, ultrasonic welding, induction welding, and dielectric welding. Any of these or other methods may be used to likewise join first sheet 110 and second sheet 120 at second edge 135 and first sheet 110 and second sheet 120 at third edge 140, as shown. Joining of first sheet 110 and second sheet 120 at first edge 130, second edge 135, and third edge 140 forms an envelope 125 within shield 100.

FIG. 1 further illustrates a means to at least temporarily seal the opening 105 of shield 100 shut using guide closure 160, Guide closure 160 comprises a tongue 170, a groove 180 and a guide 190. Tongue 170 fits into groove 180 upon a user pushing the tongue 170 into the groove 180. Guide 190 slides down the length of the tongue 170 and the groove 180 pulling the tongue 170 into the groove 180, joining the two elements and sealing the envelope 125 closed, as indicated by arrow 192. Alternatively, the shield guide 190 may be moved in the opposite direction, as indicated by arrow 194 in order to separate tongue 170 from groove 180, thereby opening the opening 125.

Alternative means may be used to open and dose the shield 100. For example, the opening 105 may be at least temporarily sealed shut by means of a tongue and groove configuration, similar to the configuration described herein, absent the guide 190. Alternatively, the opening 105 may be at least temporarily sealed shut by means of a zipper-like fastening means attached to the opening 105.

FIG. 1 further shows shield 100 comprising an antimicrobial additive 200. The antimicrobial additive 200 provides protection against microbial and harmful infections of wireless electronic devices that may infect health care professionals, patients, visitors, and others in medical care facilities. Antimicrobial additive 200 may be used to protect against many germs and microorganisms, including, but not limited to limiting the growth of bacteria, mold, fungi, MRSA, K. pneumonia, E. Coli, Pseudomonas aeruginosa, staph aureus, and A. baumannii. The presence of such germs and organisms may cause infection to patients, visitors, hospital staff, and health care professionals.

The antimicrobial additive 200 may comprise an additive distributed throughout the first sheet 110 and the second sheet 120, such that the additive 200 is distributed throughout the shield 100. As such, the shield 100 is configured to continue to kill infectious microbes continuously during use, and throughout the life of the shield 100. The additive is constantly present on the surface 102 of the shield 100. The antimicrobial additive may be mixed with the material from which the shield 100 is made, such as polyethelene, during the process of manufacturing the shield 100. The manufacture may be performed by methods known to those having skill in the art.

The growth of germs and microorganisms that are present in a medical care facilities may be inhibited by the presence of the antimicrobial additive 200 on and throughout the shield 100. The antimicrobial additive 200 may be applied to shield 100 through a chemical addition process. The antimicrobial additive 200 may comprise, but is not limited to, a silver and pyrithione mixture, wherein the silver is made up of a magnesium-aluminum-phosphorous compound, and the pyrithione comprises a bis-pyridinethionate zinc. Such additives and additive combinations inhibit the growth of bacteria, mold, and fungi. In other embodiments the antimicrobial additive may comprise a copper or copper alloy (such as, for example, brasses, bronzes, cupronickel, copper-nickel-zinc), a silver-based antimicrobial material, nanoparticles of these materials, and an ammonium based antimicrobial material. The antimicrobial additive 200 of such materials may minimize protein absorption and microbial adhesion. Additionally, the antimicrobial additive 200 may eliminate or kill the microorganisms that may contact the antimicrobial additive 200, thereby eliminating the possibility of spreading germs throughout the medical facility.

Alternatively, the antimicrobial additive 200 may comprise, but is not limited to, a chiorhexidine incorporated hydroyapatite coating, a chlorhexidine-containing polylactide coatings on an anodized surface, and polymer and calcium phosphate coatings with chlorhexidine and sodium azide. Such coatings combat the growth of bacterial cells on a surface by preventing initial adhesion of the cells to the surface.

In yet another embodiment, the antimicrobial additive 200 may comprise an antibiotic additive, which prevents the growth of bacteria on the surface of the shield 100.

Any such antimicrobial material making up the additive material 200 may cause microbes and/or microorganisms to die off, have inhibited growth, and/or adhere to the shield 100, thereby limiting their ability to spread to other areas of the medical facility. By limiting the ability of such infectious microbes to grow the possibility or likelihood of microorganisms and/or microbes spreading throughout the medical facility and infecting additional patients is greatly reduced. This will limit the spread of disease within the medical facility.

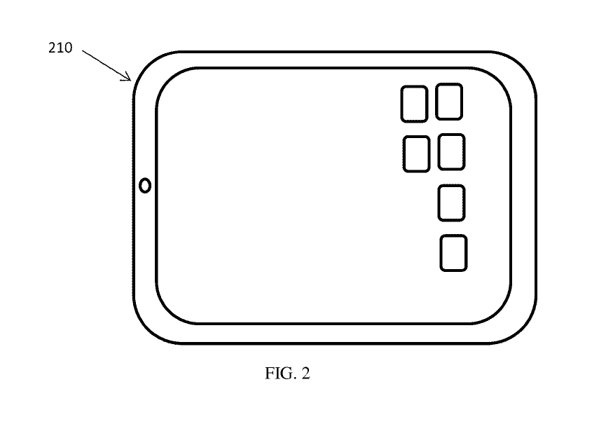

FIG. 2 illustrates a wireless electronic device 210. Wireless electronic device 210 may comprise mobile devices, including, but not limited to smart phones, tablets, electronic readers, and laptop computers. Many such wireless electronic devices have screens configured to be sensitive to the touch a user's finger, hand, or other appendage. Alternatively, a user may engage the wireless electronic device by using a stylus configured to activate the screen of the wireless electronic device. Alternatively, a wireless electronic device may comprise buttons configured to move upon being pushed by a user, whether by an appendage or a stylus. Therefore, another feature of the shield 100 is that the shield is configured to allow a user to perform all of the functions of the wireless electronic device 210 including using a touch screen interface of the wireless electronic device 210.

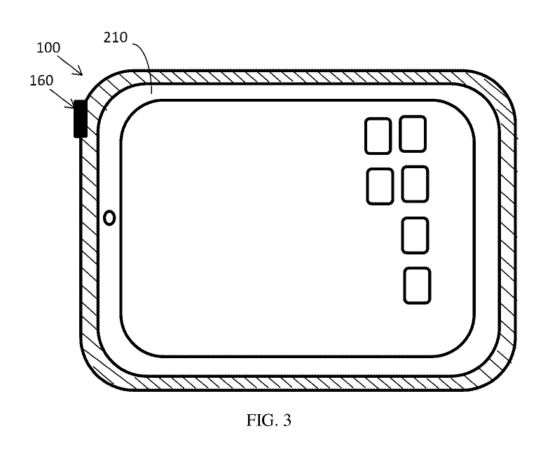

FIG. 3 shows an illustration of a wireless electronic device 210 inserted into the envelope 125 of shield 100. The zipper closure 160 of the shield 100 is closed. This allows a medical professional or healthcare worker to use a wireless electronic device 210 without the possibility of transferring germs or microorganisms to the wireless electronic device 210. instead, any germs or microorganisms would be transferred to the shield 100. The antimicrobial additive 200 would eliminate any transferred germs or microorganisms. This protection allows the medical or healthcare professional to move from patient to patient within the medical facility, bringing along the wireless electronic device 210 without the danger of contaminating other patients or spreading germs or diseases from one patient to another. This in turn helps to eliminate primary and secondary infection throughout the medical facilities. As shown in FIG. 3, the wireless electronic device may fit securely and tightly within the envelope 125. In some embodiments, the envelope 125 may be formed to fit a specific wireless electronic device or class of wireless electronic devices. After a medical professional, patient, visitor, or other individual has used the shield 100 for a period of time, the individual may dispose of the shield 100 and place the wireless electronic device 210 in a new shield. This period of time may range from one individual touching or handling the wireless electronic device within the envelope 125 to multiple or several people touching or handling the wireless electronic device. The wireless electronic device may be removed from the shield 100 and disposed of, or alternatively, in some embodiments, the shield 100 may be configured to be weak enough to be torn from the wireless electronic device and disposed of.

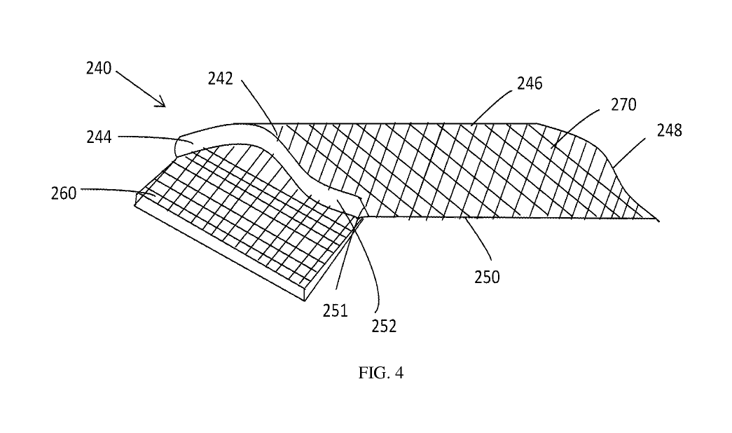

FIG. 4 shows an additional preferred embodiment of the present invention. FIG. 4 shows a shield 240, having a first sheet 242 and a second sheet 244 joined at first edge 246, second edge 248 and third edge 250, thereby forming an envelope 251. Shield 240 may further comprise an opening 252. A wireless electronic device may be inserted into opening 252. After inserting a wireless electronic device, flap 260 may be folded over to contact the first sheet 242, thereby dosing the shield 240 and preventing genus and microorganisms from coming into contact with a wireless electronic device that may be inserted into the envelope 251. The shield 240 may further comprise an antimicrobial layer 270, similar to the antimicrobial layers previously described herein.

It is further contemplated that flap 260 may comprise a section of adhesive material. The adhesive material may be covered by a non-adhesive and removable material, such as, for example, a soft plastic material, or, alternatively a paper-based material. The non-adhesive and removable material may be configured to cover the portion of flap 260 comprising the adhesive material. Prior to folding flap 260 over so that it is in contact with the first sheet 242, the non-adhesive and removable material may be removed from the adhesive material on the flap 260, such that the adhesive material is exposed. Flap 260 may be folded over to contact first sheet 242, causing the adhesive material to come into contact with the first sheet 242 and to adhere to the first sheet 242.

The adhesive material may comprise any suitable adhesive material, including an adhesive material that is configured to couple permanently to the first sheet 242 (i.e. in order to remove a wireless electronic device, the shield 240 must be cut or torn open). Alternatively the adhesive material may comprise an adhesive material that is configured to be pulled away from the first sheet 242 and is further configured to be reapplied to first sheet 242. Such adhesive materials are well-known in the art.

Additionally, the present invention is described as being used within hospitals, private medical offices, dental offices, clinics, infirmaries and other similar offices. However, other uses of the shield are further contemplated, such as use of the shield with a wireless electronic device in a food processing plant, configured to prevent the spread of food material from room to room or facility to facility.

Other embodiments of the present invention are also contemplated. These include, for example, a shield having a continuous and seamless design, having a proximal and sealable opening and a chemically added antimicrobial layer added thereto. Further embodiments may comprise a shield having multiple openings to an inner envelope.

Although the foregoing description contains many specifics, these are not to be construed as limiting the scope of the present invention, but merely as providing certain embodiments. Similarly, other embodiments of the invention may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

### Embodiments

The following describe embodiments of the present invention.

### Embodiment 1

A cover for a wireless electronic device, comprising: a shield forming an envelope defining an interior space configured to receive a wireless electronic device, the shield having at least one opening whereby a wireless electronic device may enter the envelope, the shield being configured to allow a user to operate a wireless electronic device; and an antimicrobial material disposed throughout the shield.

The cover of claim 1, wherein the shield comprises at least one of a polyethylene material and a polypropylene material.

The cover of claim 2, wherein the antimicrobial material comprises at least magnesium-aluminum-phosphorous compound and bis-pyridinethionato zinc.

The cover of claim 3, wherein the antimicrobial material is distributed throughout the shield.

The cover of claim 4, wherein the wireless electronic device comprises at least one of a cellular telephone, a smart phone, a tablet, an electronic reader, and a laptop.

The cover of claim 5, wherein the shield is configured to allow a user to perform all of the functions of the wireless electronic device including using a touch screen interface of the wireless electronic device.

The cover of claim 6, wherein the at least one opening comprises a first side and a second side, the first side and the second side being configured to be joined together forming at least temporarily sealed enclosure.

The cover of claim 7, further comprising an extension from the first side configured to fold over the second side, the extension being at least partially covered in an adhesive, wherein the opening is configured to be at least temporarily sealed upon folding the extension over the second side.

The cover of claim 8, wherein the shield is a disposable shield.

A method of making a cover for a wireless electronic device, comprising: forming a shield having an envelope defining an interior space configured to receive a wireless electronic device; forming the shield to have at least one opening wherein a wireless electronic device may enter the interior space; and chemically adding an antimicrobial substance to the disposable shield.

The method of claim 10, further comprising: forming the shield to have a rounded first corner located distally from the at least one opening and a rounded second corner located distally from the at least one opening and opposite the rounded first corner.

The method of claim 11, wherein the shield is formed and adapted to receive a wireless electronic device including at least on of a cellular telephone, a smart phone, a tablet, and a laptop.

The method of claim 12, further comprising: forming a first side and a second side of the opening; and forming a sealing means between the first side and the second side.

The method of claim 13, wherein forming a sealing means comprises forming an extended member beyond the first side the extended member configured to fold over the second side; and placing an adhesive on the extended member.

A method of using a shield for a wireless electronic device, comprising: inserting a wireless electronic device into at least one opening on the shield, the shield comprising an antimicrobial substance configured to limit the spread of bacteria; sealing closed the shield; and removing the wireless electronic device from the shield.

The method of claim 15, further comprising disposing of the shield.

Although the foregoing description contains many specifics, these are not to be construed as limiting the scope of the present invention, but merely as providing certain embodiments. Similarly, other embodiments of the invention may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

What is claimed is:

1. A cover for a wireless electronic device, comprising:
a shield forming an envelope defining an interior space configured to receive a wireless electronic device, the shield having at least one opening whereby a wireless electronic device may enter the envelope, the shield being configured to allow a user to operate a wireless electronic device; and
an antimicrobial material disposed throughout the shield.

2. The cover of claim 1, wherein the shield comprises at least one of a polyethylene material and a polypropylene material.

3. The cover of claim 2, wherein the antimicrobial material comprises at least magnesium-aluminum-phosphorous compound and bis-pyridinethionato zinc.

4. The cover of claim 3, wherein the antimicrobial material is distributed throughout the shield.

5. The cover of claim 4, wherein the wireless electronic device comprises at least one of a cellular telephone, a smart phone, a tablet, an electronic reader, and a laptop.

6. The cover of claim 5, wherein the shield is configured to allow a user to perform all of the functions of the wireless electronic device including using a touch screen interface of the wireless electronic device.

7. The cover of claim 6, wherein the at least one opening comprises a first side and a second side, the first side and the second side being configured to be joined together forming at least temporarily sealed enclosure.

8. The cover of claim 7, further comprising an extension from the first side configured to fold over the second side, the extension being at least partially covered in an adhesive, wherein the opening is configured to be at least temporarily sealed upon folding the extension over the second side.

9. The cover of claim 8, wherein the shield is a disposable shield.

10. A method of making a cover for a wireless electronic device, comprising:
forming a shield having an envelope defining an interior space configured to receive a wireless electronic device;
forming the shield to have at least one opening wherein a wireless electronic device may enter the interior space; and
chemically adding an antimicrobial substance to the disposable shield.

11. The method of claim 10, further comprising:
forming the shield to have a rounded first corner located distally from the at least one opening and a rounded second corner located distally from the at least one opening and opposite the rounded first corner.

12. The method of claim 11, wherein the shield is formed and adapted to receive a wireless electronic device including at least on of a cellular telephone, a smart phone, a tablet, and a laptop.

13. The method of claim 12, further comprising:
forming a first side and a second side of the opening; and
forming a sealing means between the first side and the second side.

14. The method of claim 13, wherein forming a sealing means comprises:
forming an extended member beyond the first side the extended member configured to fold over the second side; and
placing an adhesive on the extended member.

15. A method of using a shield for a wireless electronic device, comprising:
inserting a wireless electronic device into at least one opening on the shield, the shield comprising an antimicrobial substance configured to limit the spread of bacteria;
sealing closed the shield; and
removing the wireless electronic device from the shield.

16. The method of claim 15, further comprising disposing of the shield.
